(19) United States
(12) Patent Application Publication
(10) Pub. No.: US 2009/0201377 A1
(43) Pub. Date: Aug. 13, 2009

(54) INFORMATION TERMINAL DEVICE, INFORMATION PROCESSING SYSTEM, INFORMATION PROCESSING PROGRAM, AND INFORMATION PROCESSING METHOD

(75) Inventor: Hideo OKANO, Hanno-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 12/409,848

(22) Filed: Mar. 24, 2009

Related U.S. Application Data
(63) Continuation of application No. PCT/JP2007/068577, filed on Sep. 25, 2007.

(30) Foreign Application Priority Data
Sep. 25, 2006 (JP) 2006-259684

(51) Int. Cl. H04N 5/225

(52) U.S. Cl. 348/207.1; 348/E05.024

(57) ABSTRACT

An information terminal device such as a digital camera has one or more services, and is configured to connect to a communication network. The information terminal device has a UUID generation unit configured to generate and associate a unique UUID for each of the services, a connection unit configured to connect an external terminal device such as a kiosk terminal connected to the communication network, and a service information sending unit configured to send the external terminal device a UUID of a service permitted to connect to the external terminal device, and service information related to the permitted service.

### CROSS REFERENCE TO RELATED APPLICATIONS

This is a Continuation Application of PCT Application No. PCT/JP2007/068577, filed Sep. 25, 2007, which was published under PCT Article 21(2) in Japanese.

This application is based upon and claims the benefit of priority from prior Japanese Patent Application No. 2006-259684, filed Sep. 25, 2006, the entire contents of which are incorporated herein by reference.

### BACKGROUND OF THE INVENTION

1. Field of the Invention

The present invention relates to an information terminal device, which has one or more services, and a server function connectable to a communication network, and an information processing system, which includes the information terminal device and an external terminal device.

2. Description of the Related Art

It is a known that a conventional digital camera may be wirelessly connected to a personal computer (PC), and transmits image data to the PC. For such a digital camera, it is expected a data transmission method that image data is transmitted to a destination PC by using a mail address of the PC. However, this data transmission method has a problem which complicates the structure of a digital camera, and makes it impossible to reduce the size and weight of a camera.

Jpn. Pat. Appln. KOKAI Publication No. 2001-36791 discloses a technology for transmitting acquired image data to a PC by attaching to an electronic mail (e-mail) without complicating the structure of a camera. Namely, a digital camera transmits a structured document for setting information about connection to a computer network and address information about an e-mail, when demanded by a client (PC), and then receives from the client information about connection and address information, and a setting request for the information, and sets the information about connection and address.

### BRIEF SUMMARY OF THE INVENTION

According to a first aspect of the present invention, there is provided an information terminal device which has one or more services, and is configured to connect to a communication network, comprising: a UUID generation unit configured to generate and associate a unique UUID for each of the services; a connection unit configured to connect an external terminal device connected to the communication network; and a service information sending unit configured to send the external terminal device a UUID of a service permitted to connect to the external terminal device, and service information related to the permitted service.

According to a second aspect of the present invention, there is provided an information terminal device which has one or more services, and is configured to connect to a communication network, comprising: a connection inquiry signal sending unit configured to send a connection inquiry signal to a predetermined external terminal device connected to the communication network; a signal receiving unit configured to receive a service inquiry signal sent from the external terminal device in response to the connection inquiry signal; a connection permitted signal sending unit configured to send the external terminal device information to permit connection of a service permitted to the external terminal device in response to the service inquiry signal; a UUID generation unit configured to generate and associate a unique UUID for each of the services; and a service information sending unit configured to send the external terminal device service information related to the service including the UUID.

According to a third aspect of the present invention, there is provided an information terminal device configured to connect to an external terminal device through a communication network, comprising: a connection unit configured to connect an external terminal device on the communication network; a UUID generation unit configured to generate and associate a unique UUID for each of services usable between the external terminal device and the information terminal device; and a sending unit configured to send data together with a UUID assigned to a predetermined service, when data is sent to the external terminal device for using the predetermined service out of the above usable services.

According to a fourth aspect of the present invention, there is provided an information processing system comprising an information terminal device having a server function connectable through a communication network; and an external terminal device as a client using at least one of a server function and data provided by the information terminal device, the information terminal device comprising: a UUID generation unit configured to generate and associate a unique UUID for each service; a connection unit configured to connect an external terminal device connected to the communication network; and a service information sending unit configured to send the external terminal device a UUID of a service permitted to connect to the external terminal device, and service information related to the permitted service, and the external terminal device comprising: a storage unit configured to connect the information terminal device, acquire the UUID of the service permitted to connect by the information terminal, and service information related to the service, and store the acquired UUID and service information; and a service connection unit configured to connect the service as an existing service when the acquired UUID has been stored, and connect the service as a new service when the acquired UUID has not yet been stored.

According to a fifth aspect of the present invention, there is provided an information processing program for enabling a computer to function as an information terminal device according to the fourth aspect, wherein the information processing program enables a computer to function as the connection unit, the UUID generation unit, and the sending unit according to the fourth aspect.

According to a sixth aspect of the present invention, there is provided an information processing method in an information processing system, which includes an information terminal device having a server function connectable through a communication network; and an external terminal device as a client using at least one of a server function and data provided by the information terminal device, comprising: generating a unique UUID for each service of the information terminal device; connecting the information terminal device and the external terminal device through the communication network; sending a UUID of a service permitted to connect to the external terminal device, out of the services of the information terminal device, and service information related to the permitted service, from the information terminal device to the external terminal device; and connecting the external terminal device to the service as an existing service, when the sent UUID has been acquired in the external terminal device, and connecting the external terminal device to the service as a new service, when the sent UUID is a UUID not yet acquired in the external terminal device.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a configuration of an information processing system according to a first embodiment of the invention;

FIG. 2 is a diagram showing a configuration of a digital camera as an information terminal device according to a first embodiment of the invention;

FIG. 3 is a flowchart of establishing a wireless LAN connection between a digital camera and a kiosk terminal, when an IEEE 802.11 sequence is used;

FIG. 4 is a diagram showing a communication process in a connection sequence including a start step and a communication step;

FIG. 5 is a flowchart of establishing a wireless LAN connection between a digital camera and a kiosk terminal in an information processing system according to a second embodiment of the invention, when an IEEE 802.11 sequence is not used;

FIG. 6 is a diagram showing a communication process in a registration sequence in an information processing system according to a third embodiment of the invention;

FIG. 7A is a diagram showing a first part of a communication process in a connection sequence including a start step and a communication step, in an information processing system according to a third embodiment of the invention;

FIG. 7B is a diagram showing a second part of a communication process in the connection sequence including the start step and the communication step, in the information processing system according to the third embodiment of the invention; and

FIG. 8 is a diagram showing the outline of operations in an information processing system according to a fourth embodiment of the invention.

### DETAILED DESCRIPTION OF THE INVENTION

Hereinafter, a best mode for carrying out the invention will be explained with reference to the accompanying drawings.

### First Embodiment

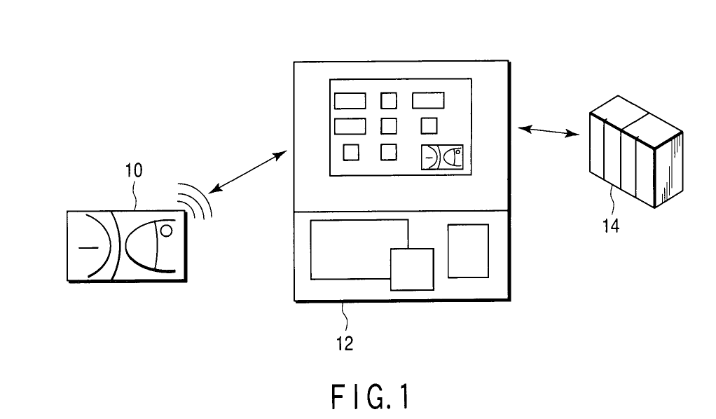

As shown in FIG. 1, an information processing system according to a first embodiment of the invention includes a digital camera 10 as an information terminal device according to a first embodiment of the invention. The digital camera 10 has a wireless communication function, and is provided with a storage medium for recording photographic images.

The information processing system further includes a kiosk terminal 12 as an external terminal device connected to the digital camera 10, and a management server 14 connected to the kiosk terminal 12. The kiosk terminal 12 has a wireless communication function for wireless connection to the digital camera 10. The kiosk terminal also has a function of displaying photographic images recorded in the storage medium of the digital camera 10, and inquiring the management server 14 about information through a network. The kiosk terminal 12 is installed at stores in many places. In FIG. 1, only one kiosk is shown as a representative for simplifying the drawing. The management server 14 is an apparatus, which has managing functions of accounting, content, and temporary storage of photographic images, and printing function of photographs, and is controlled by the kiosk terminal 12 through the network.

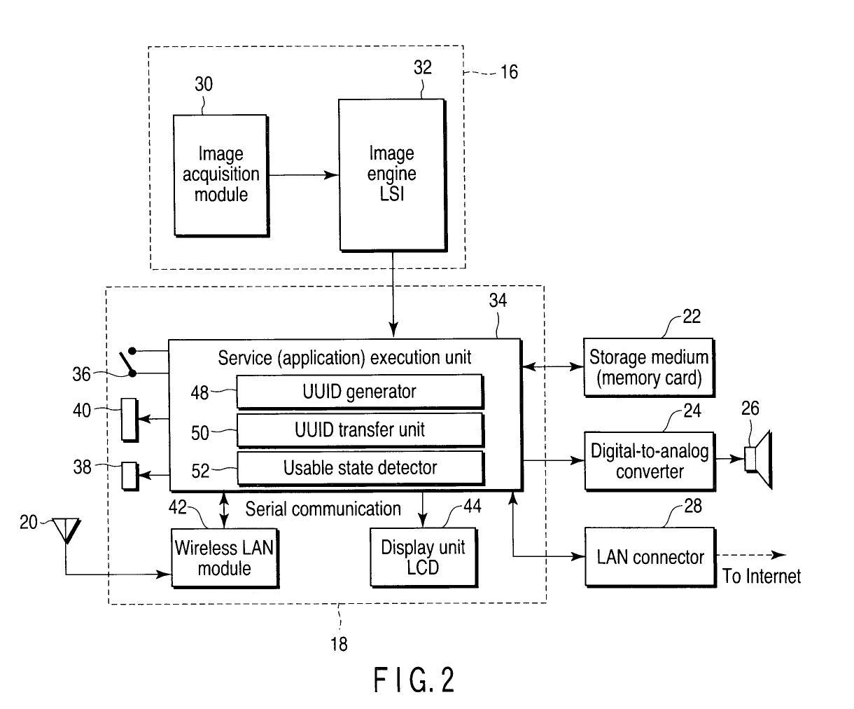

The digital camera 10 includes a camera function unit 16, an information terminal unit 18, an antenna 20, a storage medium 22, a digital-to-analog converter 24, a speaker 26, and a LAN connector 28, as shown in FIG. 2.

The camera function unit 16 includes an image acquisition module 30 which includes an image acquisition lens and an image sensor, and an image engine LSI 32 which performs signal processing such as gamma correction and white balance, compression for an image signal acquired by the image acquisition module 30.

The information terminal unit 18 includes a service (application) execution unit 34 comprising a CPU and a memory, an operation unit 36 connected to the service execution unit 34, an LED 38, an IrDA 40, a wireless LAN module 42, and a display unit LCD 44.

The service execution unit 34 executes one or more services (applications), and controls the functions of the information terminal unit 18. The service execution unit 34 is configured to realize the functions of the information terminal unit 18 by sequentially executing an information processing program stored in the CPU or an external nonvolatile memory, etc. by the CPU. Further, the service execution unit 34 is provided with a UUID generator 48, a UUID transfer unit 50, and a usable state detector 52. The UUID generator 48 generates and associates a Universally Unique Identifier (UUID) described in Request For Comment (RFC) 4122, whose technical specifications are disclosed in Internet Engineering Task Force (IETF), for each of the above services. The UUID transfer unit 50 transfers the UUID generated and associated by the UUID generator 48, to the outside through the wireless LAN module 42. The usable state detector 52 detects whether a specified service is usable for the kiosk terminal 12, based on event information transferred to/from the kiosk terminal 12.

The operation unit 36 is a member such as a shutter button and a cross key operated by a user. The LED 38 is a light-emitting part to notify the user of the states of the digital camera 10. The IrDA 40 is an infrared ray emission part to transmit information to the outside by infrared rays. The wireless LAN module 42 is used for wireless communication with the kiosk terminal 12 through the antenna 20. The display unit LCD 44 displays photographic images acquired with the camera function unit 16, and displays a menu and various information according to operations of the operation unit 36.

The storage medium 22 is a memory card, for example, for saving photographic images acquired with the camera function unit 16, and may be either removable or not removable from the digital camera 10.

The digital-to-analog converter 24 converts a message generated by the service execution unit 34 to notify the user of the state of the digital camera 10, into an analog audio signal, and reproduces it through the speaker 26.

The LAN connector 28 is used for wired connection to the Internet through a cable (not shown).

Next, an explanation will be given on the operations of the information processing system configured as described above.

Before starting communication between the digital camera 10 and kiosk terminal 12 through the wireless LAN, a setting necessary for establishing initial setting for communication is performed in the digital camera 10 and/or kiosk terminal 12. This enables the digital camera 10 to start communication with the kiosk terminal 12, and reduces the processing amount in the kiosk terminal 12 at the time of starting communication.

Conventionally, the digital camera 10 and kiosk terminal 12 are connected through a universal serial bus (USB) cable, their network setting information is exchanged, and simple initial setting is registered, and then, the digital camera 10 is turned on to start communication. For the case of wireless communication, the digital camera 10 starts communication with the kiosk terminal 12, and the kiosk terminal 12 starts an existing communication procedure, whereby initial setting can be made with small environmental changes. More specifically, when the camera and terminal are wirelessly connected, a sequence indicating the existence of the digital camera 10 just like setting a USB is executed in a wireless communication protocol. Namely, in the communication between the initialized digital camera 10 and kiosk terminal 12, the sequence is executed when wireless LAN transmission/reception is possible (the digital camera 10 is turned on, initial setting is completed, and communication is ready).

In an IEEE 802.11 sequence, a service set identifier (SSID) is used as one of network identifiers on a wireless LAN. A SSID functions as a so-called network name.

In the case of network configuration in infrastructure mode, one basic access point and a network comprising a plurality of wireless LAN terminal are called a basic service set (BSS), and an identifier used in the network is called a BSSID. A network comprising a plurality of BSS is called an ESS, and an identifier used in the network is called an extended SSID (ESSID) (in this specification, a SSID indicates an ESSID unless otherwise specified). Setting of SSID is used to prevent connection of an unintended network, or to identify a terminal or equipment to be connected. Namely, connection is impossible unless the same SSID is set for an access point and a wireless LAN terminal. By using this function, the number of users can be limited by a certain extent. An access point periodically distributes packet data called a beacon. A beacon packet includes a SSID name of an access point necessary for a wireless LAN terminal to make connection. Therefore, it is possible to notify the existence of an access point to a wireless LAN terminal existing in a range in which the wave reaches. It is also possible to know a SSID name from a beacon by using some kind of setting utility software. Therefore, it is possible to automatically establish connection by receiving a beacon and setting a SSID.

A beacon includes an automatic setting data part (including an element ID, a sending command length, an ID, a format type, etc.), and an application part (including a device type, a UUID, a service reference URL, a device name, and an IP address). In this embodiment, the UUID transfer unit 50 in the service execution unit 34 of the digital camera 10 transmits a beacon, which includes a unique ID code (UUID) generated by the UUID generator 48 to identify the digital camera 10 itself as information for detecting a device, in the application part, from the wireless LAN module 42 through the antenna 20.

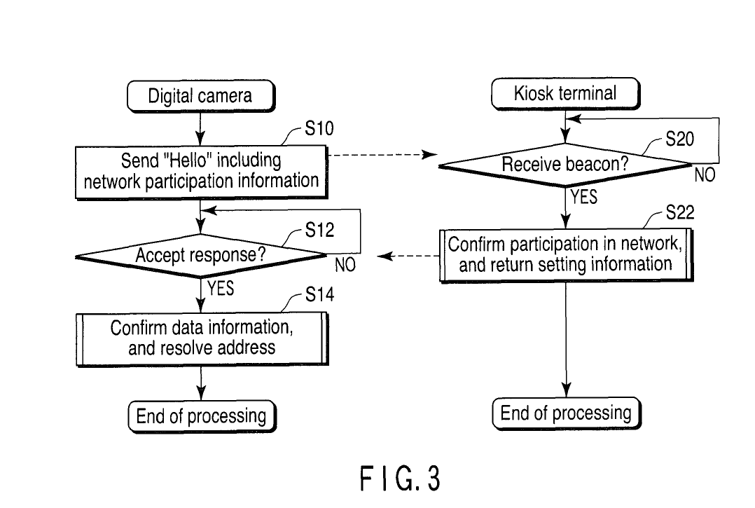

When the above IEEE 802.11 sequence is used, a procedure of establishing wireless LAN connection is executed by the service execution unit 34 of the digital camera 10 and the application of the kiosk terminal 12 in the information processing system according to this embodiment, as shown in FIG. 3.

Namely, first, the digital camera 10 sends a beacon including network participation information for starting participation in a network by using the IEEE 802.11 sequence (step S10). (The network participation information is also called a connection inquiry signal).

The application of the kiosk terminal 12 receives the beacon (step S20), confirms participation in the network, and returns setting information (step S22). Namely, the application of the kiosk terminal detects a device (the digital camera 10) by the received beacon, detects a UUID, and determines whether the terminal is connectable to the network. Inquire the management server 14 indicated by a service reference URL about the UUID number. Alternatively, check whether the UUID number has been registered as a connectable device in the kiosk terminal 12. When the terminal is connectable, the terminal is connected to the network, and the terminal sends the digital camera 10 the IP address of the kiosk terminal 12, or an external terminal UUID as URL address information, as setting information.

The digital camera 10 accepts the response from the kiosk terminal 12 (step S16), confirms the data information, and executes an address solution procedure (step S14).

When the wireless LAN connection is established as described above, known authentication is executed between the digital camera 10 and kiosk terminal 12, and the kiosk terminal 12 starts a communication procedure for starting communication (e.g., detecting and identifying a device [the digital camera 10]). Namely, the kiosk terminal 12 requests the digital camera 10 to send the data of the above known communication procedure. Thereafter, in the communication procedure, an icon (ICON) is displayed on the display unit (not shown) of the kiosk terminal 12 according to a plug and play (PnP) procedure, and when the icon is clicked, the kiosk terminal 12 provides a display for starting communication.

Thereafter, the digital camera 10 instructs the kiosk terminal 12 to start a known communication procedure, such as a universal PnP (UPnP) procedure, for example. The kiosk terminal 12 accepts the instruction, and starts the known communication procedure such as UPnP from the kiosk terminal 12. In other words, in this embodiment, a procedure of starting communication under the initiative of the digital camera 10 is added before the known communication procedure such as UPnP. This makes it possible to use a limited communication procedure, in which communication can be started only from the kiosk terminal 12, regardless of the limitations.

For communication between the digital camera 10 and kiosk terminal 12 via a wireless LAN network, it is necessary to automatically data transfer of connection information between the digital camera 10 and kiosk terminal 12, and to execute a registration sequence for setting communication setting information necessary for the communication. Namely, in the registration sequence, the digital camera 10 and kiosk terminal 12 are connected via a USB cable. The power of the digital camera 10 is turned on, and the link with the management server 14 through the kiosk terminal 12 is confirmed. Next, information necessary for wireless connection such as a device name and address is stored as registration information in the digital camera 10 and kiosk terminal 12, and/or a folder of the management server 14, to facilitate subsequent settings. Finally, the connection between the digital camera 10 and kiosk terminal 12 is released, whereby the setting of the camera and terminal is completed.

After the above registration sequence is completed, a start step for starting communication from the digital camera 10 to the kiosk terminal 12 through a wireless LAN network (communication process by the Hypertext Transfer Protocol [HTTP]), and a communication step for making communication from the digital camera 10 to the kiosk terminal 12 through a wireless LAN network (communication process based on the UPnP specifications) are sequentially executed. These steps can be executed any time after the above registration sequence is completed.

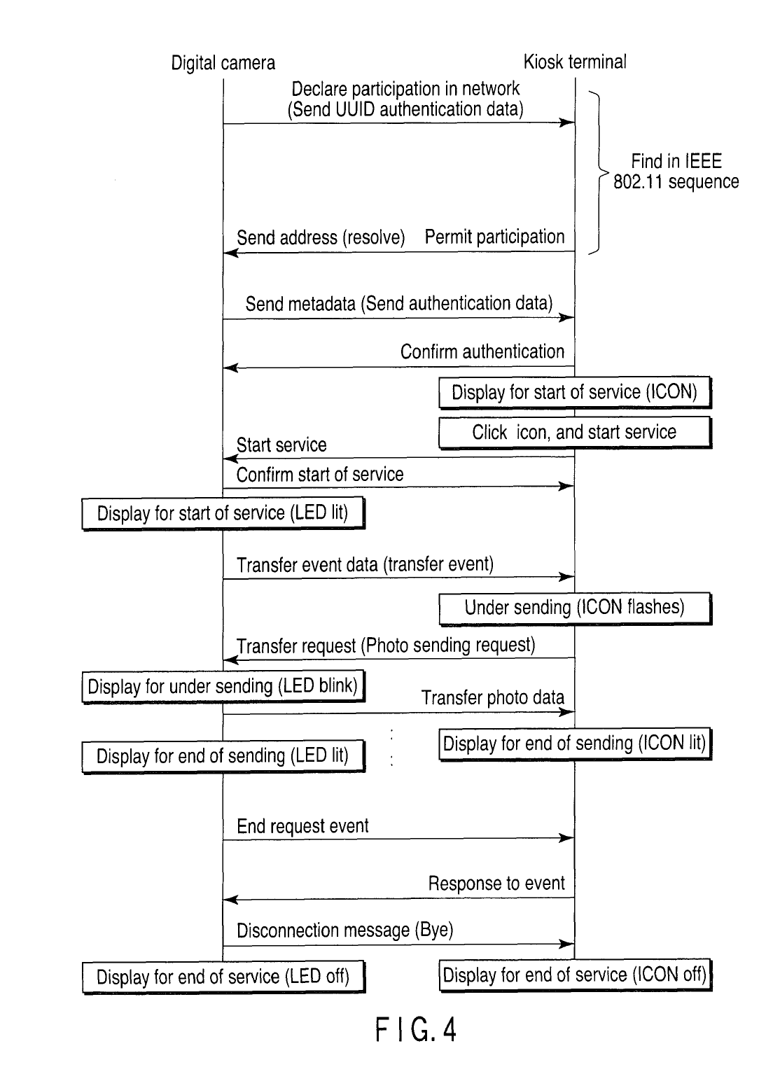

An explanation is given on a communication process in a connection sequence including the above start step and communication step, by referring to FIG. 4.

First, in the start step, a procedure of establishing wireless LAN connection is executed by using the sequence IEEE 802.11, as shown in FIG. 3. When the wireless LAN connection is established, the digital camera 10 sends authentication data to the kiosk terminal 12, and the kiosk terminal 12 executes confirmation of authentication.

The service execution unit 34 of the digital camera 10 starts its own application, and sends a connection request to the kiosk terminal 12. The application in the kiosk terminal 12 receives the request, and returns a response message to the digital camera 10. The digital camera 10 sends the kiosk terminal 12 a request to start a predetermined application, and prepares for data transmission. The application in the kiosk terminal 12 receives the request, and starts the corresponding application. The application notifies the user that the digital camera 10 participates in a network, by displaying an icon on the display unit of the kiosk terminal 12 or emitting an audible alarm. The user clicks the icon in the kiosk terminal 12 (the user's first click), whereby the kiosk terminal 12 informs the digital camera 10 of the start of service. Namely, the terminal sends a service inquiry signal. The digital camera 10 confirms the start of service, namely sends the kiosk terminal 12 information to permit connection of service, and informs the user of the start of service by means of the LED 38 or other displays provided in the main body of the digital camera 10, or by an audible signal through the speaker 26.

Next, a communication process based on the UPnP specifications is executed. Namely, the application of the kiosk terminal 12 requests the digital camera 10 to sequentially transfer the file information of an image file which conforms to predetermined conditions (file information [update time and creation time, access time and file names] and attribute information [image sizes, photographing information, and thumbnail images, etc.]) included in a header of an image file, out of image files of photographic images stored in the storage medium 22, for example, and the thumbnail image data included in the header of the image file. The digital camera 10 receives the transfer request, and sends the kiosk terminal 12 the data conforming to the above predetermined conditions by adding a UUID. The kiosk terminal 12 receives the data. During transmission of the data, the displayed icon flashes in the kiosk terminal 12, and the LED 38 blinks and an audible alarm is emitted through the speaker in the digital camera 10, to notify the user that the data is under transmission.

When the data transmission is completed, the icon is displayed in the kiosk terminal 12, and the LED 38 is lit and an audible alarm indicating the end of data transmission is emitted through the speaker in the digital camera 10, whereby the user is notified the end of data communication. Thereafter, the digital camera 10 sends the kiosk terminal 12 a finish request event for requiring finish of the service, and the application of the kiosk terminal 12 receives the event, and return a response. The digital camera 10 receives the response, and sends a disconnection message to the kiosk terminal 12. The kiosk terminal 12 finishes the service according to the disconnection message. At this time, the kiosk terminal 12 turns off the icon as a sign of the end of service, and the digital camera 10 turns off the LED 38, and emits an audible alarm indicating the end of service through the speaker, to notify the user of the end of service.

The digital camera 10 may be set to automatically turn off when a service is finished. Namely, in the method described above, communication is set between the digital camera 10 and kiosk terminal 12, and data is transferred only by the amount necessary for processing in the kiosk terminal 12 at the time of starting communication. Therefore, as the digital camera 10 initiates communication with the kiosk terminal 12, the digital camera 10 can be turned on only when making communication with the kiosk terminal 12, and turned off at all other times.

The user retrieves photographic image data wanted to print or to save in the management server 14, from the thumbnail images sent to the kiosk terminal 12. Thereafter, the user turns on again the digital camera 10, establishes the wireless LAN connection as described above, operates the kiosk terminal 12, and transfers the image data together with a UUID from the digital camera 10 to the kiosk terminal 12. After confirming the photographic image data transferred to the kiosk terminal 12, the user can save the data in the management server 14, or print the data with a printer connected to the kiosk terminal 12 or by a print service provided by the management server 14.

As described above, according to the first embodiment, the digital camera 10 is automatically detected when it enters the service area of the kiosk terminal 12, and is wirelessly connected to the kiosk terminal 12. Therefore, even if the destination kiosk terminal 12 is frequently changed, the connection can be easily established by changing the destination, image data conforming to predetermined conditions can be quickly viewed, and information can be simultaneously registered and downloaded.

Therefore, by using the digital camera 10 which can be easily connected to a destination even if a destination (remote terminal) is frequently changed, the user can easily and quickly detect and authenticate the digital camera 10 at the kiosk terminal 12 installed in stores near the user's home, office, destination in travel, etc.

Further, by using the digital camera 10 which can be easily connected to a destination even if a destination (remote terminal) is frequently changed, the user can find desired image data wanted to print or save in the management server 14, and execute a desired operation by confirming the image, while displaying thumbnails conforming to predetermined conditions at the kiosk terminal 12 installed at a store or other places.

Even during retrieving, the user can directly transfer detected photographic image data to a printer, and make an order, bypassing the management server 14.

### Second Embodiment

An information processing system according to a second embodiment of the invention does not use the IEEE 802.11 sequence.

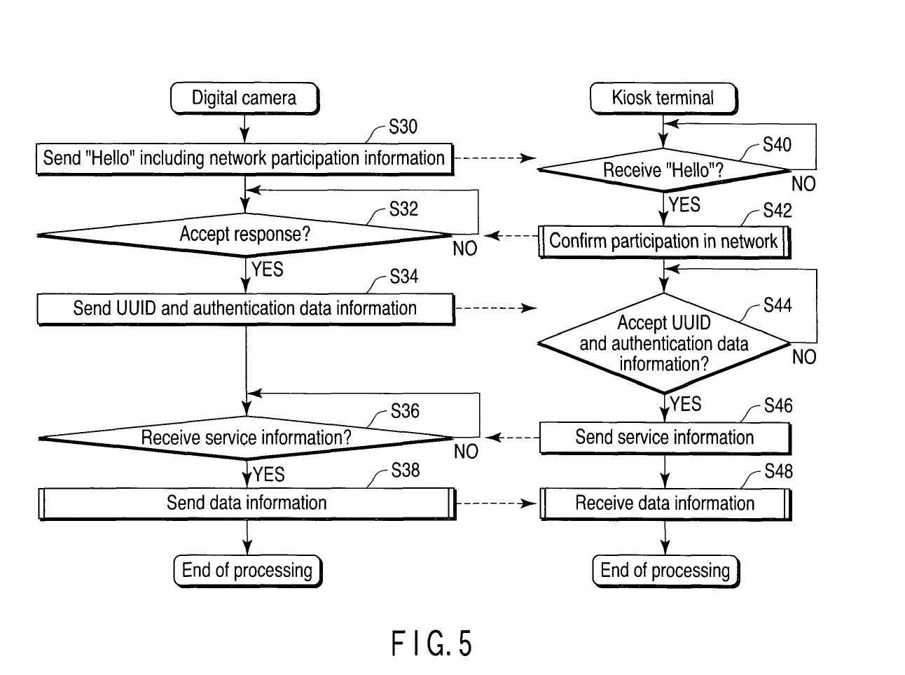

An explanation will be given on the operation of establishing wireless LAN connection by the service execution unit 34 of the digital camera 10 and the application of the kiosk terminal 12, when the IEEE 802.11 sequence is not used, with reference to FIG. 5.

First, the digital camera 10 sends the kiosk terminal 12 network participation information to start participation in a network (step S30).

The application of the kiosk terminal 12 receives the network participation information (step S40), and confirms the participation in the network, and returns a participation permitted signal to the digital camera 10 (step S42).

The digital camera 10 receives the participation permitted signal (step S32), and sends the address of the digital camera 10 to the kiosk terminal 12. The kiosk terminal 12 receives and resolves the address, and sends an authentication data request to the digital camera 10. According to the authentication data request, the digital camera 10 automatically generates a unique UUID to identify the digital camera 10 in the UUID generator 48, and sends the UUID and authentication data to the kiosk terminal 12 (step S34).

The kiosk terminal 12 receives the UUID and authentication data (step S44), and recognizes the UUID, resolves the address, and sends the digital camera 10 the address information of the kiosk terminal 12 and a unique external terminal UUID. At this time, the kiosk terminal 12 notifies the user that the digital camera 10 participates in the network, by displaying an icon on the display unit of the kiosk terminal 12, and emitting an audible alarm.

The user clicks the icon in the kiosk terminal 12 (the user's first click), whereby the kiosk terminal 12 informs the digital camera 10 of the start of service (step S46).

Thereafter, the communication process based on the UPnP specifications is executed as explained in the first embodiment. Namely, the digital camera 10 sends the data information as explained in the first embodiment (step S38), and the kiosk terminal 12 receives the data information as explained in the first embodiment (step S48).

Therefore, the same effects as those in the first embodiment can be obtained in the second embodiment.

### Third Embodiment

In a third embodiment of the invention, the digital camera 10 as an information terminal device accesses the management server 14 on the Internet through the kiosk terminal 12 as a client terminal, confirms participation in a network, and connects to a service.

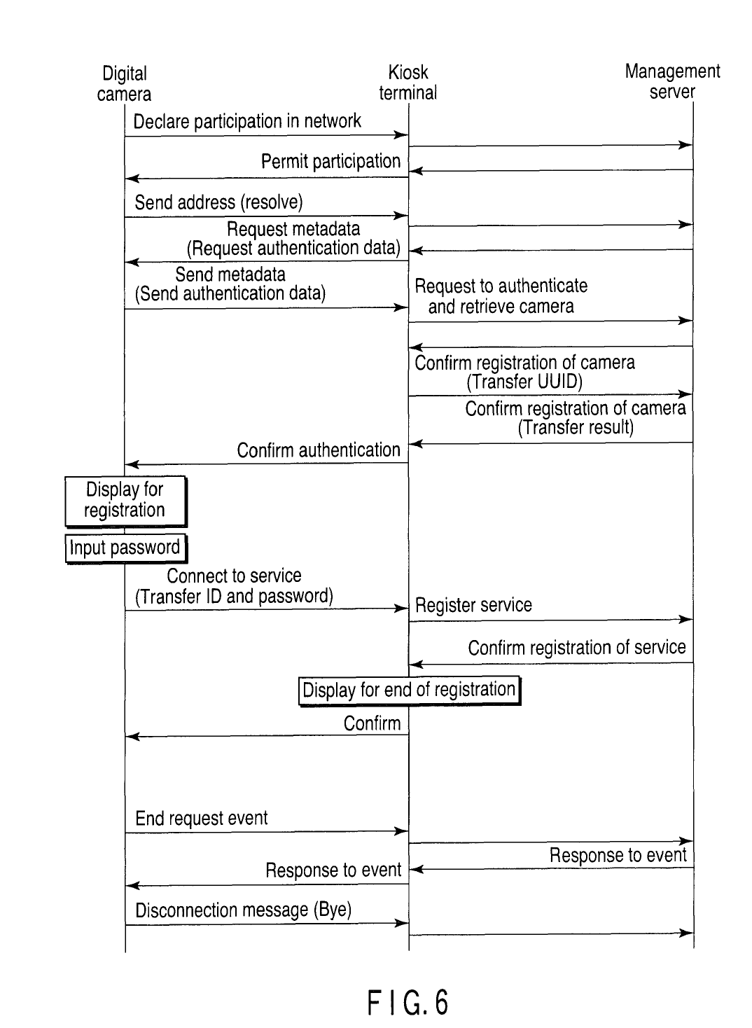

An explanation will be given of a communication process in a registration sequence in an information processing system according to this embodiment with reference to FIG. 6.

In a start step, the digital camera 10 sends the kiosk terminal 12 network participation information to start participation in a network. The digital camera 10 previously stores an IP address (WAN address) of the management server 14 connectable from the outside, and sends the IP address or URL together with the network participation information. The application of the kiosk terminal 12 receives the network participation information, and transfers it to the management server 14 indicated by the IP address or URL. The management server 14 confirms the participation in a network, and returns a participation permitted signal. The kiosk terminal 12 transfers the participation permitted signal to the digital camera 10.

The digital camera 10 receives the participation permitted signal, and sends the address of the digital camera 10 to the kiosk terminal 12. The kiosk terminal 12 transfers the address to the management server 14. The management server 14 resolves the address based on the transferred address, and sends an authentication data request to the kiosk terminal 12. The kiosk terminal 12 transfers the authentication request to the digital camera 10.

According to the authentication data request, the digital camera 10 automatically generates a unique UUID to identify the digital camera 10 itself in the UUID generator 48, and sends the UUID together with authentication data to the kiosk terminal 12. The kiosk terminal 12 sends the management server 14 a request to authenticate/retrieve the digital camera 10 together with the received authentication data. The management server 14 authenticates the digital camera 10 based on the authentication data, and returns the result of authentication to the kiosk terminal 12. When the result indicates that the digital camera 10 has been authenticated, the kiosk terminal 12 transfers the UUID sent from the digital camera 10 to the management server 14, and requests the management server 14 to confirm registration of the digital camera 10. The management server 14 confirms whether the digital camera 10 has been registered by retrieving the previously registered UUIDs by using the transferred UUID, and transfers the result to the kiosk terminal 12. When the digital camera 10 has not been registered, the kiosk terminal 12 sends the digital camera 10 authentication confirmed information to request registration.

The digital camera 10 receives the authentication confirmed information, and displays a registration screen on the display unit LCD 44. At this time, an audible alarm may be emitted through the speaker 26 to attract the attention of the user. The digital camera 10 accepts a login ID and a password entered by the user from the operation unit 36, and sends the login ID and password to the kiosk terminal 12. The kiosk terminal 12 transfers the login ID and password to the management server 14 as a request to register a service. The management server 14 registers the login ID and password by associating with the UUID sent when the registration is confirmed. After completing the above operation, the management server 14 returns the service registration confirmation to the kiosk terminal 12. The kiosk terminal 12 receives the service registration confirmation, and displays the end of registration on a not-shown display unit.

When the user confirms the registration information displayed on the display unit of the kiosk terminal 12 and inputs OK by operating the kiosk terminal 12, the kiosk terminal 12 sends the confirmation information to the digital camera 10. The digital camera 10 receives the confirmation information, and returns a finish request event to the kiosk terminal 12. The kiosk terminal 12 transfers the finish request event to the management server 14, and the management server 14 receives the finish request event and returns a response indicating acceptance of the event to the kiosk terminal 12. The kiosk terminal 12 transfers the event response to the digital camera 10. The digital camera 10 receives the event response, and sends a disconnection message to the kiosk terminal 12. The kiosk terminal 12 transfers the disconnection message to the management server 14, and releases the connection. The management server 14 terminates the registration by the reception of the disconnection message. At this time, the kiosk terminal 12 provides a display for disconnection, and the digital camera 10 turns off the LED 38 or emits an audible disconnection signal through the speaker 26, thereby notifying the user that the connection is released. Further, the digital camera 10 may be set to automatically turn off at this time.

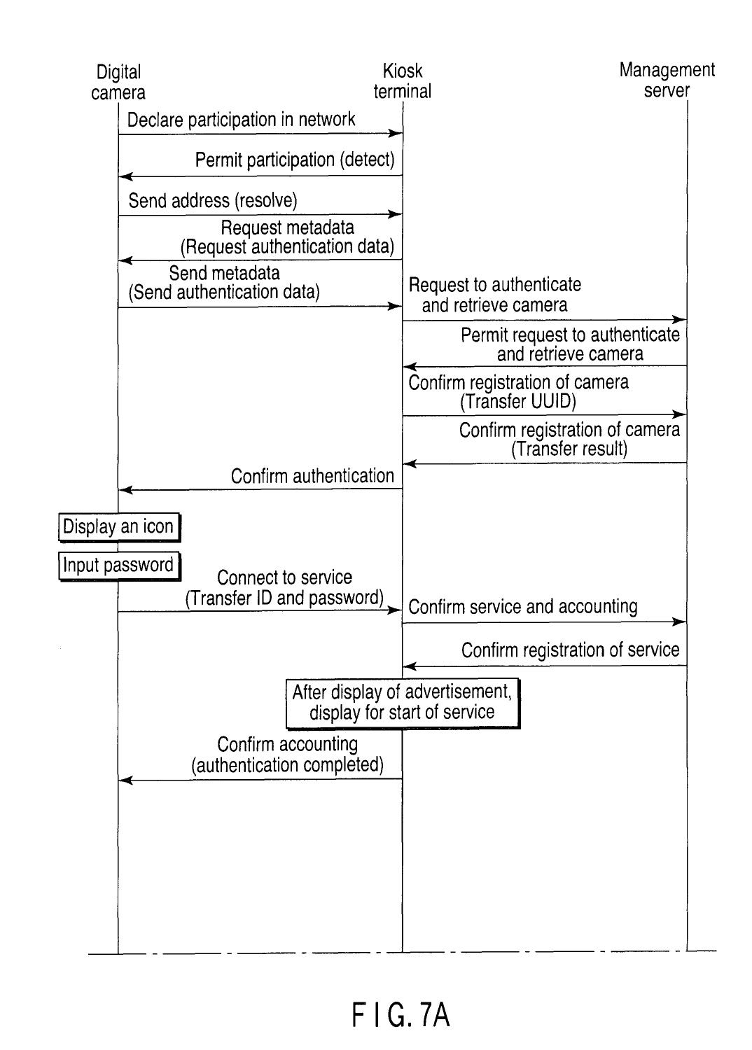

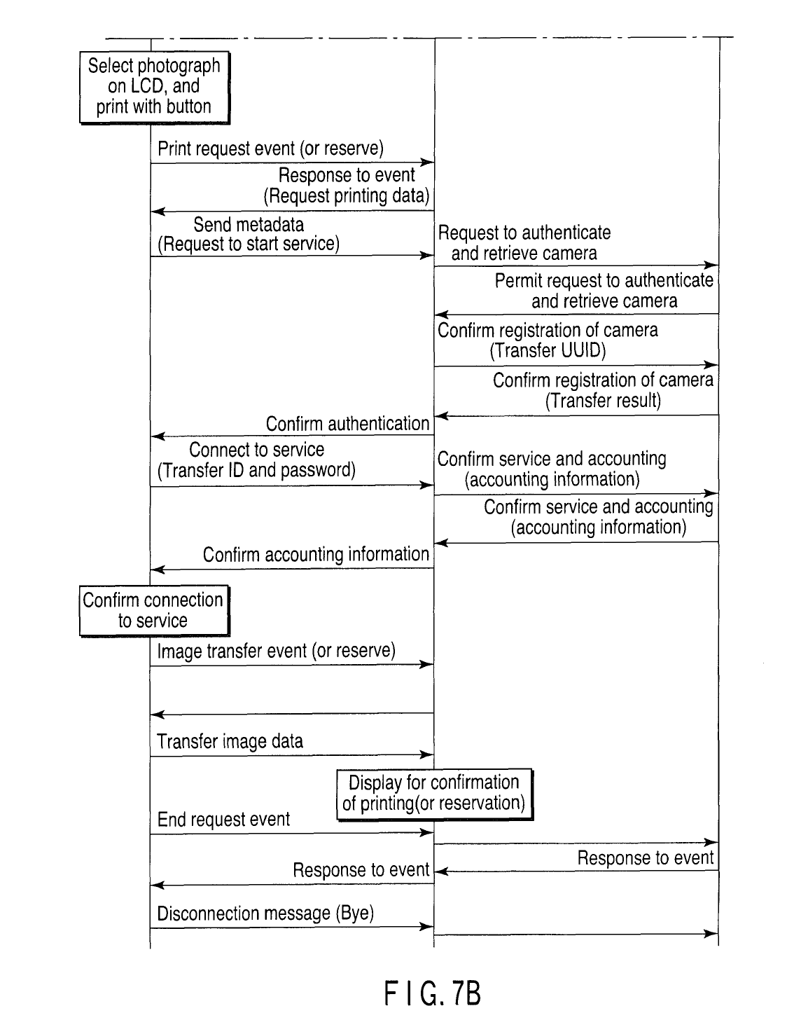

Next, an explanation will be given of a communication process in a connection sequence including a start step and a communication step of the information processing system according to this embodiment with reference to FIGS. 7A and 7B.

First, in the start step, the digital camera 10 sends the kiosk terminal 12 network participation information to start participation in a network. The application of the kiosk terminal 12 receives the network participation information, confirms the participation in a network, and returns a participation permitted signal to the digital camera 10. The digital camera 10 receives the participation permitted signal, and sends the address of the digital camera 10 to the kiosk terminal 12. The kiosk terminal 12 receives and resolves the address, and sends an authentication data request to the digital camera 10. According to the authentication data request, the digital camera 10 automatically generates a unique UUID to identify the digital camera 10 in the UUID generator 48, and sends the UUID together with authentication data to the kiosk terminal 12.

The kiosk terminal 12 sends the management server 14 a request to authenticate and retrieve the digital camera 19 together with the received authentication data. The management server 14 authenticates the digital camera 10 based on the authentication data, and returns the result of authentication to the kiosk terminal 12. When the result indicates that the digital camera 10 has been authenticated, the kiosk terminal 12 transfers the UUID sent from the digital camera 10 to the management server 14, and requests the management server 14 to confirm registration of the digital camera 10. The management server 14 confirms whether the digital camera 10 has been registered by retrieving the previously registered UUID by using the transferred UUID, and transfers the result to the kiosk terminal 12. When the digital camera 10 has been registered, the kiosk terminal 12 sends the digital camera 10 authentication confirmed information indicating that the digital camera is authenticated.

The digital camera 10 receives the authentication confirmed information, and displays an icon on the display unit LCD 44. At this time, an audible alarm may be emitted through the speaker 26 to attract the attention of the user. The digital camera 10 accepts a password entered by the user from the operation unit 36, and sends a login ID and password to the kiosk terminal 12. The kiosk terminal 12 transfers a service and accounting confirmation request including the login ID and password to the management server 14. The management server 14 compares the login ID and password with the login ID and password previously registered in association with the UUID received when confirming the registration of the digital camera 10, and if they are identical, returns a service and accounting confirmed information to the kiosk terminal 12. The kiosk terminal 12 receives the confirmation information, and displays an advertisement on a not-shown display unit. After the display of the advertisement is finished, the kiosk terminal 12 provides a display for the start of service, and sends the digital camera 10 the accounting confirmed information indicating the end of authentication. As an advertisement, there are map information in an area including the kiosk terminal 12, shopping information, news, etc.

The user confirms the above display for the start of service start in the kiosk terminal 12, operates the operation unit 36, selects a desired one of the photographic images saved in the storage medium 22, while monitoring the display on the display unit LCD 44, and instructs to print the image.

By the above operation, the communication process is started. The digital camera 10 sends a print request (or reservation) event to the kiosk terminal 12. According to the print request event, the kiosk terminal 12 sends the digital camera 10 a response event to request printing data. According to the response event, the digital camera 10 sends a service start request to the kiosk terminal 12. According to the serve start request, the kiosk terminal 12 sends the management server 14 a request to authenticate/retrieve the digital camera 10. According to the authentication/retrieve request, the management server 14 authenticates the digital camera 10, and returns the result of authentication to the kiosk terminal 12. When the result indicates that the digital camera 10 has been authenticated, the kiosk terminal 12 transfers the UUID sent from the digital camera 10 to the management server 14, and requests the management server 14 to confirm registration of the digital camera 10. The management server 14 confirms whether the digital camera 10 has been registered by retrieving the previously registered UUIDS by using the transferred UUID, and transfers the result to the kiosk terminal 12. When the digital camera 10 has been registered, the kiosk terminal 12 sends the digital camera 10 authentication confirmed information indicating that the digital camera is authenticated.

The digital camera 10 receives the authentication confirmed information, and sends the previously input login ID and password to the kiosk terminal 12. The kiosk terminal 12 transfers the login ID and password, and a service and accounting confirmation request including accounting information indicating the end of advertisement display. According to the accounting confirmation request, the management server 14 confirms the login ID and password, updates the accounting information corresponding to the UUID of the digital camera 10, and returns a service and accounting confirmed information to the kiosk terminal 12. The kiosk terminal 12 receives the confirmed information, and sends the digital camera 10 accounting confirmed information indicating that the accounting operation is completed.

According to the accounting confirmed information, the digital camera 10 provides a confirmation display on the display unit LCD 44. At this time, an audible alarm may be emitted through the speaker 26 to attract the attention of the user. To transfer the selected photographic image data, the digital camera 10 first sends an image transfer (or reserve) event to the kiosk terminal 12. According to the image transfer event, the kiosk terminal 12 sends the digital camera 10 a response event indicating acceptance of the event. According to the response event, the digital camera 10 sends the kiosk terminal 12 the selected photographic image data together with the UUID. According to the image data, the kiosk terminal 12 provides a display to confirm printing (or reservation) on the display unit.

The user confirms the confirmation display, and instructs printing (or reservation) by operating a not-shown operation unit of the kiosk terminal 12. Thereby, the selected image data can be printed (or reserved for printing) with the printer connected to the kiosk terminal 12, or by a print service provided by the management server 14.

Thereafter, when the user instructs to finish the operation by operating the operation unit 36 of the digital camera 10, the digital camera 10 sends a finish request event to the kiosk terminal 12. The kiosk terminal 12 transfers the finish request event to the management server 14 and the management server 14 receives the finish request event, and returns a response indicating acceptance of the event to the kiosk terminal 12. The kiosk terminal 12 transfers the event response to the digital camera 10. The digital camera 10 receives the event response, and sends a disconnection message to the kiosk terminal 12. The kiosk terminal 12 transfers the disconnection message to the management server 14, and releases the connection. The management server 14 receives the disconnection message, and terminates the service. At this time, the kiosk terminal 12 provides a display for the end of connection, the digital camera 10 indicates the end of connection by lighting the LED 38 or by providing a display on the display unit LCD 44, or emits an audible alarm indicating the end of connection through the speaker, thereby notifying the user that the connection is released. Further, the digital camera 10 may be set to automatically turn off at this time.

In the above explanation, printing is taken as an example. The explanation is also applicable to a service of temporary saving content data such as photographic images in the management server 14.

As described above, in this embodiment, the charge for using a network in accessing the management server 14 by using a network such as the Internet is reduced or made free of charge by means of display an advertisement on the kiosk terminal 12. It is of course permitted to use a print service or a service of temporarily saving photographic images, without displaying an advertisement, after authentication for accounting the charge for using a service via an Internet provider service (IPS) previously registered in the digital camera 10. The user may select a method of connection.

### Fourth Embodiment

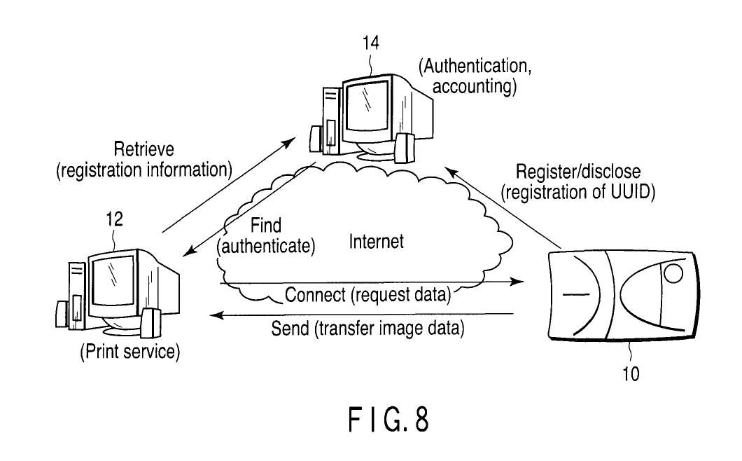

In an information processing system according to a fourth embodiment shown in FIG. 8, a digital camera 10 can be connected to a network wirelessly or through a wire, a kiosk terminal 12 can automatically detect that the digital camera 10 participates in a network within its wireless communication area, and acquires a UUID of the digital camera 10.

Based on the acquired UUID, the kiosk terminal 12 can determine whether to provide an accounting operation in the management server 14, or a service based on the information about usable infrastructures such as wireless communication. For example, when there has been a contract with an Internet service provider to participate in a network, the digital camera 10 is authenticated by that the digital camera 10 sends information about confirmation and authentication of a source of accounting the charge for using a service as device information by meta-data, and the kiosk terminal 12 inquires the management server 14 about the connection. At this time, the digital camera 10 transfers the meta-data including a predetermined special number, an encoded password, a login ID, a name and a UUID, thereby setting them in the management server 14. Thereafter, they will be used for automatic identification of the digital camera 10, or transfer of condition data. At this time, the meta-data is encrypted. The kiosk terminal 12 can recognize the relationship between the login ID and UUID.

In particular, when the kiosk terminal 12 detects that a new device (digital camera 10) is connected within its wireless communication area, and the kiosk terminal 12 and the detected digital camera 10 display a fact that the kiosk terminal detects the digital camera, the above operations is performed and a usable icon can be displayed if a service usable for the digital camera 10. If the digital camera 10 automatically inputs its password, the kiosk terminal 12 can permit the digital camera to enter the service by clicking the icon.

The digital camera 10 permitted to use the service can automatically and temporarily enter the service by confirming a predetermined special number (e.g., an external terminal UUID) and an encoded login ID and password to identify the kiosk terminal 12, contained in the meta-data sent from the kiosk terminal 12 (the kiosk terminal 12 can set limits on the time and numbers of the connection to a service by making retrieval and authentication of the management server 14 as described above).

When the digital camera 10 enters a service after making retrieval and authentication of the management server 14, the kiosk terminal sequentially acquires the file information of an image file, which conforms to the UUID and preset conditions (file information [update time, creation time, access time and file names]), out of the image files of the photographic images saved in the storage medium 22, and the attribute information (image sizes, imaging information, thumbnail images, etc.) included in the header of the image file, and the thumbnail image data included in the header of the image file, and displays a thumbnail screen on the display unit of the kiosk terminal 12.

When the retrieved thumbnail image is selected during or after the data transfer, the image data of the image file corresponding to the thumbnail image is transferred to a predetermined printer on a network. During the transfer of the image data of the image file, transmission of the image data is given higher priority.

When the image data is accepted by the destination printer, the printer transfers a print end or expected end date and time to the digital camera 10. At this time, the digital camera 10 encodes the transfer destination designated by user and transfers it to the management server 14 which accepts the order. The history is also transferred. It is preferable that the image data is directly transferred to the printer, and the data is not distributed to and not remained in the management server 14.

When printing is instructed as described above, advertisement information is simultaneously transferred and partially viewed at no charge. The user can exchange information about registration of photographic images, but it is desirable to specify refuse as default.

It is permitted that when a banner of advertisement information is clicked when printing is instructed, the advertisement and order information are downloaded from the kiosk terminal 12 to the digital camera 10, and predetermined data such as a UUID, a login ID and a password is given within a certain limited period.

A series of operations, accounting and printing information are all transferred to the digital camera 10, but backup information is encoded and transferred to the management server 14 on a network.

When the operation is completed and a device is logged off the management server 14, permission for a series of services, a UUID for ordering an advertisement, a login ID and a password are erased. It is desirable that the content of a series of operations, accounting and print information is made viewable from the digital camera 10 (blog records).

The embodiments of the invention have been explained herein. The invention is not limited to the embodiments described herein. The invention may be modified and applied in various forms without departing from its essential characteristics.

For example, the digital camera 10 is used as an information terminal device in the embodiments. An information terminal device may be a portable content reproduction device, a PDA, a cellular phone or other portable devices, which have a large capacity storage medium for saving voluminous content data such as photographic images and music. Similarly, the kiosk terminal 12 is used as an external terminal and a client terminal device in the embodiments. A client PC or other external devices may be used instead.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information terminal device which has one or more services, and is configured to connect to a communication network, comprising:
a UUID generation unit configured to generate and associate a unique UUID for each of the services;
a connection unit configured to connect an external terminal device connected to the communication network; and
a service information sending unit configured to send the external terminal device a UUID of a service permitted to connect to the external terminal device, and service information related to the permitted service.

2. The information terminal device according to claim 1, wherein the connection unit includes a connection inquiry signal sending unit configured to send a connection inquiry signal to a predetermined external terminal device connected to the communication network, and
the service information sending unit sends the service information to the external terminal device at the same time when the connection inquiry signal is sent.

3. The information terminal device according to claim 1, further comprising an external terminal information acquisition unit configured to acquire and store a unique external terminal UUID generated in the external terminal device for using the service, and connection address information of the external terminal.

4. The information terminal device according to claim 1, wherein the service is a content data transfer service for transferring content data between the information terminal device and the external terminal device, and
the service adds and transfers the UUID to the content data when the content data is transferred.

5. The information terminal device according to claim 4, further comprising:
a service usable state detection unit configured to detect a usable state of a predetermined service of the information terminal device, when the UUID is sent; and
a notification unit configured to provide at least one of a display and an audible signal to indicate the usable state of the predetermined service.

6. The information terminal device according to claim 5, wherein the service usable state detection unit detects whether the external terminal device is enabled to use the predetermined service of the information terminal device, and
the notification means provides at least one of a display and an audible signal to indicate that the external terminal device is enabled to use the predetermined service, when the service usable state detection unit detects that the external terminal device is enabled to use the predetermined service.

7. The information terminal device according to claim 5, wherein the service usable state detection unit detects a content data transfer state between the information terminal device and the external terminal device, and
the notification unit provides at least one of a display and an audible signal to indicate that the content data is under transfer, when the content data is under transfer between the information terminal device and the external terminal device.

8. The information terminal device according to claim 5, wherein the service usable state detection unit detects whether the predetermined service is unusable between the external terminal device and the information terminal device, and
the notification unit provides at least one of a display and an audible signal to indicate that the predetermined service is unusable between the external terminal device and the information terminal device, when the predetermined service is unusable between the external terminal device and the information terminal device.

9. The information terminal device according to claim 4, further comprising a content data transfer control unit configured to send the external terminal device only the content selected under predetermined conditions out of the content data stored in the information terminal device.

10. The information terminal device according to claim 9, wherein the content data is image data,
the information terminal device further comprises:
a thumbnail data sending unit configured to send the external terminal device the thumbnail data of the image data stored in the information terminal device; and
a receiving unit configured to receive image data selection information of image data, which is transferred from the information terminal device to the external terminal device, from the external terminal device, the image data selection information being generated in the external terminal device in response to the transmission of the thumbnail data, and
the content data transfer control unit transfers only the image data selected by the selection information, to one of the external terminal device and a content storage server, the content storage server existing on the communication network and being configured to store the content data.

11. The information terminal device according to claim 9, further comprising a service usable state detection unit configured to detect a service usable state of a predetermined service of the information terminal device,
wherein the content data transfer control means automatically transfers content data, when the service usable state detection unit detects that the external terminal device is enabled to use the predetermined service.

12. The information terminal device according to claim 1, further comprising:
a service usable state detection unit configured to detect a usable state of a predetermined service of the information terminal device, when the UUID is sent; and
a notification unit configured to provide at least one of a display and an audible signal to indicate the usable state of the predetermined service.

13. The information terminal device according to claim 1, further comprising:
an advertisement data display unit configured to display advertisement data in response to a user's instruction, when the external terminal device is connected; and
an acquisition unit configured to acquire predetermined data, after the advertisement data is displayed.

14. An information terminal device which has one or more services, and is configured to connect to a communication network, comprising:
a connection inquiry signal sending unit configured to send a connection inquiry signal to a predetermined external terminal device connected to the communication network;
a signal receiving unit configured to receive a service inquiry signal sent from the external terminal device in response to the connection inquiry signal;
a connection permitted signal sending unit configured to send the external terminal device information to permit connection of a service permitted to the external terminal device in response to the service inquiry signal;
a UUID generation unit configured to generate and associate a unique UUID for each of the services; and
a service information sending unit configured to send the external terminal device service information related to the service including the UUID.

15. The information terminal device according to claim 14, further comprising an external terminal information acquisition unit configured to acquire and store a unique external terminal UUID generated in the external terminal device for using the service, and connection address information of the external terminal.

16. The information terminal device according to claim 14, wherein the service is a content data transfer service for transferring content data between the information terminal device and the external terminal device, and
the service adds and transfers the UUID to the content data when the content data is transferred.

17. The information terminal device according to claim 14, further comprising:
a service usable state detection unit configured to detect a usable state of a predetermined service of the information terminal device, when the UUID is sent; and
a notification unit configured to provide at least one of a display and an audible signal to indicate the usable state of the predetermined service.

18. The information terminal device according to claim 14, further comprising:
an advertisement data display unit configured to display advertisement data in response to a user's instruction, when the external terminal device is connected; and
an acquisition unit configured to acquire predetermined data, after the advertisement data is displayed.

19. An information terminal device configured to connect to an external terminal device through a communication network, comprising:
a connection unit configured to connect an external terminal device on the communication network;
a UUID generation unit configured to generate and associate a unique UUID for each of services usable between the external terminal device and the information terminal device; and
a sending unit configured to send data together with a UUID assigned to a predetermined service, when data is sent to the external terminal device for using the predetermined service out of the above usable services.

20. An information processing system comprising an information terminal device having a server function connectable through a communication network; and an external terminal device as a client using at least one of a server function and data provided by the information terminal device,
the information terminal device comprising:
a UUID generation unit configured to generate and associate a unique UUID for each service;
a connection unit configured to connect an external terminal device connected to the communication network; and
a service information sending unit configured to send the external terminal device a UUID of a service permitted to connect to the external terminal device, and service information related to the permitted service, and
the external terminal device comprising:
a storage unit configured to connect the information terminal device, acquire the UUID of the service permitted to connect by the information terminal, and service information related to the service, and store the acquired UUID and service information; and
a service connection unit configured to connect the service as an existing service when the acquired UUID has been stored, and connect the service as a new service when the acquired UUID has not yet been stored.

21. An information processing program for enabling a computer to function as an information terminal device according to claim 19, wherein the information processing program enables a computer to function as the connection unit, the UUID generation unit, and the sending unit according to claim 19.

22. An information processing method in an information processing system, which includes an information terminal device having a server function connectable through a communication network; and an external terminal device as a client using at least one of a server function and data provided by the information terminal device, comprising:
generating a unique UUID for each service of the information terminal device;
connecting the information terminal device and the external terminal device through the communication network;
sending a UUID of a service permitted to connect to the external terminal device, out of the services of the information terminal device, and service information related to the permitted service, from the information terminal device to the external terminal device; and
connecting the external terminal device to the service as an existing service, when the sent UUID has been acquired in the external terminal device, and connecting the external terminal device to the service as a new service, when the sent UUID is a UUID not yet acquired in the external terminal device.
